(19) United States
(12) Patent Application Publication
(10) Pub. No.: US 2021/0203447 A1
(43) Pub. Date: Jul. 1, 2021

(54) Coexistence Operation Enhancement Under Frequency-Division Duplexing Mode

(71) Applicant: MediaTek Inc., Hsinchu City (TW)

(72) Inventors: I-Cheng Tsai, Hsinchu City (TW); Tsai Yuan Hsu, Hsinchu City (TW)

(21) Appl. No.: 17/129,073

(22) Filed: Dec. 21, 2020

Related U.S. Application Data
(60) Provisional application No. 62/953,624, filed on Dec. 26, 2019.

(51) Int. Cl. H04L 1/00; H04W 16/14; H04L 5/14; H04B 17/318; H04W 52/24; H04W 28/22; H04W 28/02

(52) U.S. Cl. CPC H04L 1/0068; H04W 16/14; H04L 5/1469; H04W 28/0268; H04W 52/242; H04W 28/22; H04B 17/318

(57) ABSTRACT

An apparatus identifies an onset of a coexistence scenario involving simultaneous transmission and receiving using a first wireless technology and a second wireless technology different from the first technology, respectively, in wireless communications with one other apparatus under a frequency-division duplexing (FDD) mode. The apparatus determines an upper limit on transmission rates responsive to identifying the onset of the coexistence scenario. The apparatus then performs transmissions at or without exceeding the upper limit until the coexistence scenario is over.

### CROSS REFERENCE TO RELATED PATENT APPLICATION

The present disclosure is part of a non-provisional patent application claiming the priority benefit of U.S. Provisional Patent Application No. 62/953,624, filed 26 Dec. 2019, the content of which being incorporated by reference in its entirety.

### TECHNICAL FIELD

The present disclosure is generally related to wireless communications and, more particularly, to coexistence operation enhancement under frequency-division duplexing (FDD) mode.

### BACKGROUND

Unless otherwise indicated herein, approaches described in this section are not prior art to the claims listed below and are not admitted as prior art by inclusion in this section.

As demand for networking and inter-device connectivity continue to rise, more and more devices with the capability of wirelessly communications via more than one technologies, standards or protocols. For instance, a present-day smartphone is typically capable of wireless communications in compliance with the Institute of Electrical and Electronics Engineers (IEEE) 802.11 standard(s), the 3^{rd} Generation Partnership Project (3GPP) specifications for Long-Term Evolution (LTE) and/or New Radio (NR), as well as Bluetooth. In other words, there are often different wireless systems in a modern-day communication device, and this tends to result in in-device coexistence (IDC) interference. In view of IDC and performance requirements, a communication device with coexisting wireless systems would typically limit its transmit power in one wireless system, especially when the transmission is under FDD mode, in order to reduce or otherwise mitigate the interference on another wireless system.

On the other hand, packets in high-rate physical layer (PHY) modulation require sufficient signal-to-noise ratio (SNR) to be received by a receiving peer device. That is, the SNR is proportional to the power level of the transmit power and, hence, power limit is associated with lower SNR. Undesirably, a lower SNR would negatively impact the reception of high-rate packets. There is, therefore, a need for a solution to enhance coexistence operation under FDD mode for coexisting wireless systems.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to coexistence operation enhancement under FDD mode. Under various proposed schemes in accordance with the present disclosure, transmission rate may be limited without packets to probe and determine a proper rate when a coexistence scenario occurs in an apparatus with multiple wireless systems. For instance, under various proposed schemes, the transmission rate may be determined based on a path loss of a channel between the apparatus and a target device. Alternatively, the transmission rate may be determined using a histogram of packet error rate.

In one aspect, a method may involve a processor of a first apparatus identifying an onset of a coexistence scenario involving simultaneous transmission and receiving using a first wireless technology and a second wireless technology different from the first technology, respectively, in wireless communications with a second apparatus under a FDD mode. The method may also involve the processor determining an upper limit on transmission rates responsive to identifying the onset of the coexistence scenario. The method may further involve the processor performing transmissions at or without exceeding the upper limit until the coexistence scenario is over.

In another aspect, an apparatus may include a first transceiver, a second transceiver and a processor coupled to control the first transceiver and the second transceiver. The first transceiver may be configured to wirelessly transmit and receive using a first wireless technology. The second transceiver may be configured to wirelessly transmit and receive using a second technology different from the first technology. The processor may be configured to identify an onset of a coexistence scenario involving simultaneous transmission and receiving using the first wireless technology and the second wireless technology, respectively, in wireless communications with one other apparatus under a FDD mode. The processor may be also configured to determine an upper limit of transmission rates responsive to identifying the onset of the coexistence scenario. The processor may be further configured to perform, via the first transceiver and the second transceiver, transmissions at or without exceeding the upper limit until the coexistence scenario is over.

It is noteworthy that, although description provided herein may be in the context of certain radio access technologies, networks and network topologies such as, Wi-Fi and Bluetooth, the proposed concepts, schemes and any variation(s)/derivative(s) thereof may be implemented in, for and by other types of radio access technologies, networks and network topologies such as, for example and without limitation, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example communication environment in which various solutions and schemes in accordance with the present disclosure may be implemented.

FIG. 2 is a diagram of an example procedure in accordance with the present disclosure.

FIG. 3 is a diagram of example procedures in accordance with the present disclosure.

FIG. 4 is a diagram of an example procedure in accordance with the present disclosure.

FIG. 5 is a diagram of an example simulation result in accordance with the present disclosure.

FIG. 6 is a block diagram of an example communication system in accordance with an implementation of the present disclosure.

FIG. 7 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to coexistence operation enhancement under FDD mode. According to the present disclosure, a number of possible solutions may be implemented separately or jointly. That is, although these possible solutions may be described below separately, two or more of these possible solutions may be implemented in one combination or another.

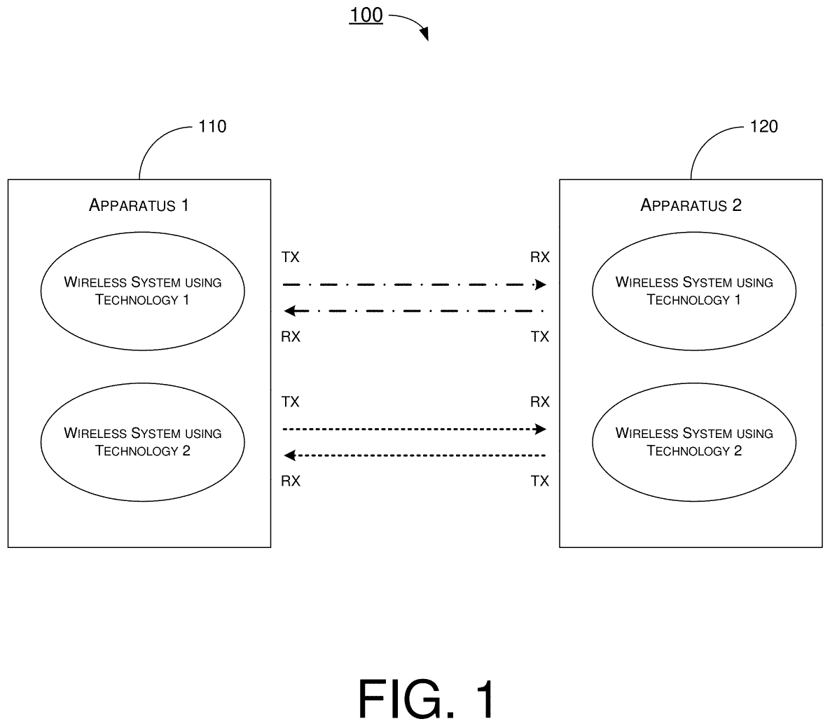

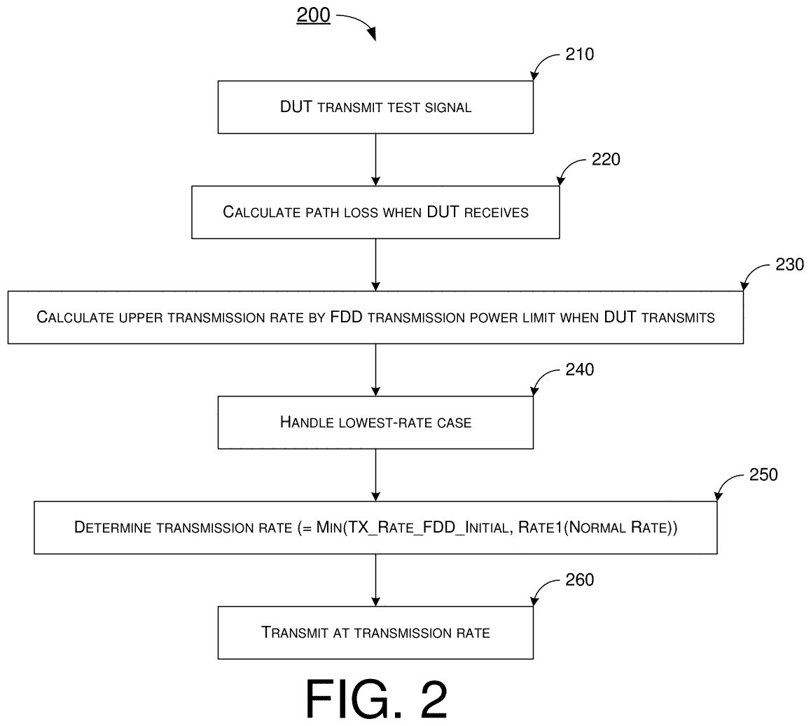

FIG. 1 illustrates an example communication environment 100 in which various solutions and schemes in accordance with the present disclosure may be implemented. FIG. 2-FIG. 5 illustrate examples of implementation of various proposed schemes in communication environment 100 in accordance with the present disclosure. The following description of various proposed schemes is provided with reference to FIG. 1-FIG. 5.

Referring to FIG. 1, communication environment 100 may involve a first apparatus or communication device 110 and a second apparatus or communication device 120 communicating wirelessly with each other using one or more technologies. More specifically, each of first apparatus 110 and second apparatus 120 may be equipped with multiple wireless systems (e.g., Wi-Fi and Bluetooth, and optionally one or more other wireless systems such as LTE and/or NR) and, thus, each of first apparatus 110 and second apparatus 120 may encounter a coexistence scenario when at least two of its multiple wireless systems carry out transmission (TX) and receiving (RX) simultaneously. In the example shown in FIG. 1, each of first apparatus 110 and second apparatus 120 is shown to have at least a first wireless system using a first technology (herein denoted as “technology 1”) and a second wireless system using a second technology (herein denoted as “technology 2”). When first wireless system of first apparatus 110 transmits using first technology, first wireless system of second apparatus 120 receives correspondingly using first technology. Moreover, when first wireless system of second apparatus 120 transmits using first technology, first wireless system of first apparatus 110 receives correspondingly using first technology. Similarly, when second wireless system of first apparatus 110 transmits using second technology, second wireless system of second apparatus 120 receives correspondingly second technology. Likewise, when second wireless system of second apparatus 120 transmits using second technology, second wireless system of first apparatus 110 receives correspondingly using second technology.

As an example, first technology and second technology may include Bluetooth and Wi-Fi. Accordingly, a coexistence scenario may occur when the Bluetooth wireless system of first apparatus 110 is receiving (herein denoted as “BT_RX”) under the FDD mode while the Wi-Fi wireless system of first apparatus 110 is transmitting (herein denoted as “Wi-Fi_TX”) under the FDD mode or when the Bluetooth wireless system of first apparatus 110 is transmitting (herein denoted as “BT_TX”) under the FDD mode while the Wi-Fi wireless system of first apparatus 110 is receiving (herein denoted as “Wi-Fi_RX”) under the FDD mode. The same may be said about second apparatus 120.

Traditionally, in a coexistence scenario under the FDD mode or in which special reuse is involved, each of first apparatus 110 and second apparatus 120 may adapt a transmission rate automatically by a per-packet error count or a retry count. However, by doing so, the problem of power limit would degrade overall throughput because, in case of insufficient SNR margin, there would likely be packet transmission retries or re-attempts, each time with a different or lower transmission rate, which would negatively impact throughput.

FIG. 2 illustrates an example procedure 200 in accordance with the present disclosure. Under a proposed scheme in accordance with a present disclosure, when each of first apparatus 110 and second apparatus 120 is to wirelessly communicate with each other under the FDD mode, each of first apparatus 110 and second apparatus 120 may implement procedure 200 to enhance its coexistence operation under FDD mode. With procedure 200, each of first apparatus 110 and second apparatus 120 may directly limit its transmission rate to a given value (e.g., a lower rate than a ‘normal’ rate when not in a coexistence scenario) instead performing numerous transmission retries to find a suitable transmission rate, thereby avoiding waste in airtime as well as excessive power consumption.

Procedure 200 may include one or more operations, actions, or functions as represented by one or more of blocks 210, 220, 230, 240, 250 and 260. Although illustrated as discrete blocks, various blocks of procedure 200 may be divided into additional blocks, combined into fewer blocks, or eliminated, depending on the desired implementation. For simplicity and in the interest of brevity, description of procedure 100 below is provided from the perspective of first apparatus 110, although the same may be applicable to second apparatus 120. Procedure 200 may begin at 210.

At 210, procedure 200 may involve second apparatus 120, as a peer apparatus (herein denoted as “device under test” or “DUT”) of first apparatus 110, transmitting one or more test signals to first apparatus 110 via one or more of its wireless systems (e.g., Wi-Fi and Bluetooth). Procedure 200 may proceed from 210 to 220.

At 220, procedure 200 may involve first apparatus 110 calculating an estimated path loss from the perspective of second apparatus 120. Procedure 200 may proceed from 220 to 230. For instance, first apparatus 110 may calculate the estimated path loss based on an estimated transmission power of second apparatus 120, a received signal strength indication (RSSI) of the test signal(s) received from second apparatus 120 (herein denoted as “RX RSSI”) and a delta margin. The estimation may be expressed mathematically as follows:

Path Loss=Estimated TX Power of Peer−RX RSSI−Delta Margin

At 230, procedure 200 may involve first apparatus 110 calculating an upper boundary or limit on its transmission rate based on a transmission power limit under FDD mode when second apparatus 120, as the DUT, transmits to first apparatus 110. For instance, procedure 200 may involve first apparatus 110 determining the upper boundary or limit on its transmission power (herein denoted as “FDD_Tx_power_limit”) based on the estimated path loss (herein denoted as “path_loss”) and a receiving sensitivity of second apparatus 120 (herein denoted as “Rx_spec_sensitivity”). As an illustration and without limiting the scope of the present disclosure, an example logic for determining whether a given upper boundary or limit on transmission power would result in a successful transmission:

```
if (FDD_Tx_power_limit) − path_loss > Rx_spec_sensitivity
  Tx success;
else
  Tx failure;
endif
so check
for(rate_idx = 0; rate_idex < Max_rate; rate_idx++) {
  if(FDD_Tx_power_limit − path_loss < Rx_spec_sensitivity[rate_idx])
    {
    rate_idx -- //fall back to previous successful rate
    return;
    }
}
```

For instance, first apparatus 110 may initially be transmitting at a higher rate according to modulation and coding scheme (MCS) 7 and, due to onset of a coexistence scenario under FDD, first apparatus 110 may determine to lower its transmission to a lower rate according to MCS 4 which satisfies the determined upper limit on transmission power. In an event that first apparatus 110 determines that a suitable transmission rate that is required in order to satisfy the upper limit on transmission power is its lowest rate (e.g., a low rate according to MCS 2) or needs to be even lower, procedure 200 may proceed from 230 to 240.

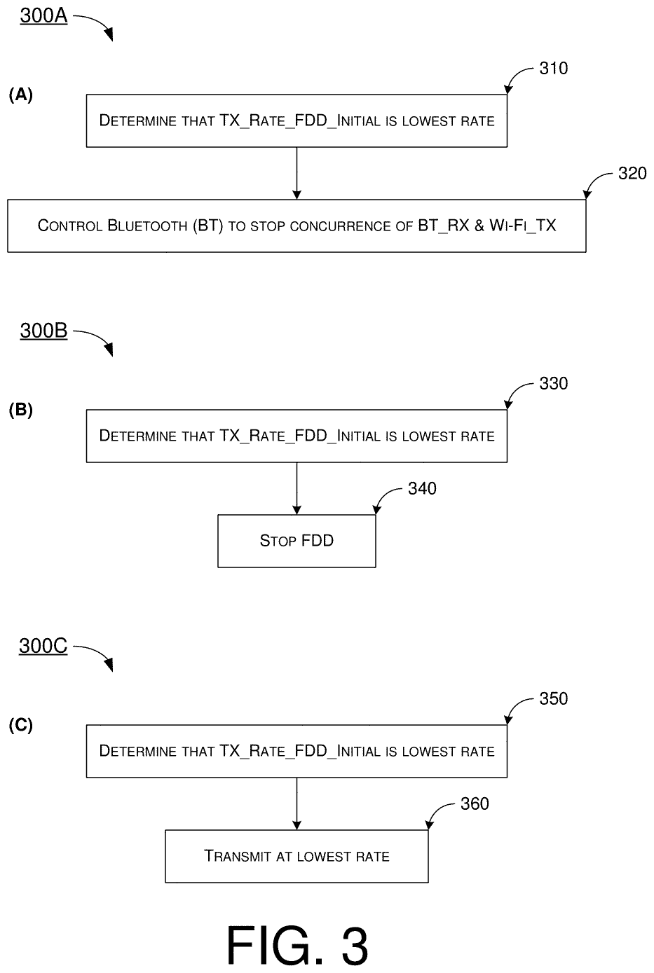

At 240, procedure 200 may involve first apparatus 110 handling the case of the determined transmission rate being the lowest transmission rate of a plurality of transmission rates of first apparatus 110, or even lower. Specifically, procedure 200 may involve first apparatus 110 performing one of a number of sub-procedures shown in FIG. 3 and described below. Procedure 200 may proceed from 240 to 250.

At 250, procedure 200 may involve first apparatus 110 determining its initial transmission rate (herein denoted as “TX_Rate_FDD_initial”) when in the coexistence scenario to be a rate corresponding to the upper limit on transmission power as determined above or a normal rate when not in the coexistence scenario (herein denoted as “Rate1(normal rate)”), whichever is lower. That is, first apparatus 110 may set its transmission rate to be equal to Min(TX_Rate_FDD_initial, Rate1(normal rate)). Procedure 200 may proceed from 250 to 260.

At 260, procedure 200 may involve first apparatus 110 performing transmission at the above-determined transmission rate when in the coexistence scenario under FDD mode.

FIG. 3 illustrates an example procedures 300A, 300B and 300C in accordance with the present disclosure. Each of procedures 300A, 300B and 300C may be an error handling procedure utilized in case that the determination or search of a given upper boundary or limit that would result in a successful transmission results in failure. Procedure 300A may include one or more operations, actions, or functions as represented by one or more of blocks 310 and 320. Procedure 300B may include one or more operations, actions, or functions as represented by one or more of blocks 330 and 340. Procedure 300C may include one or more operations, actions, or functions as represented by one or more of blocks 350 and 360. Although illustrated as discrete blocks, various blocks of each of procedures 300A, 300B and 300C may be divided into additional blocks, combined into fewer blocks, or eliminated, depending on the desired implementation. For simplicity and in the interest of brevity, description of each of procedures 300A, 300B and 300C below is provided from the perspective of first apparatus 110, although the same may be applicable to second apparatus 120.

At 310, procedure 300A may involve first apparatus 110 determining that TX_Rate_FDD_initial is the lowest transmission rate among a plurality of transmission rates by which first apparatus 110 may perform transmissions, or even lower. Procedure 300A may proceed from 310 to 320.

At 320, procedure 300A may involve first apparatus 110 controlling its Bluetooth wireless system to refrain, stop or otherwise avoid concurrence of BT_RX and Wi-Fi_TX under the FDD mode. For instance, first apparatus 110 may control its Bluetooth wireless system to stop receiving while its Wi-Fi wireless system is transmitting to second apparatus 120.

At 330, procedure 300B may involve first apparatus 110 determining that TX_Rate_FDD_initial is the lowest transmission rate among a plurality of transmission rates by which first apparatus 110 may perform transmissions, or even lower. Procedure 300B may proceed from 330 to 340.

At 340, procedure 300B may involve first apparatus 110 stopping operation(s) under the FDD mode. For instance, first apparatus 110 may switch from the FDD mode to a time-division duplexing (TDD) mode for TX/RX operations.

At 350, procedure 300C may involve first apparatus 110 determining that TX_Rate_FDD_initial is the lowest transmission rate among a plurality of transmission rates by which first apparatus 110 may perform transmissions, or even lower. Procedure 300C may proceed from 350 to 360.

At 360, procedure 300C may involve first apparatus 110 setting and maintaining its transmission rate to its lowest transmission rate, at least for the duration of the coexistence scenario under FDD mode.

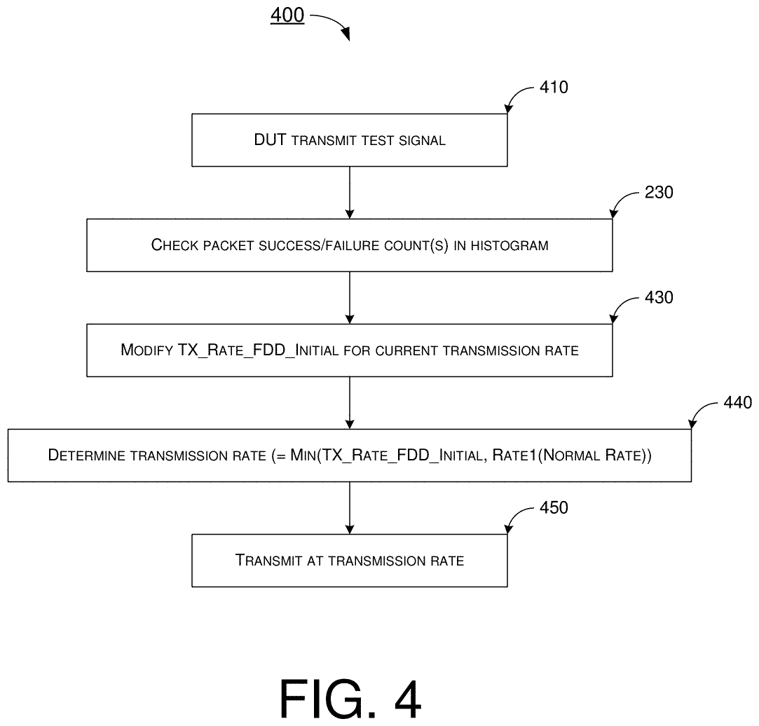

FIG. 4 illustrates an example procedure 400 in accordance with the present disclosure. Under a proposed scheme in accordance with a present disclosure, when each of first apparatus 110 and second apparatus 120 is to wirelessly communicate with each other under the FDD mode, each of first apparatus 110 and second apparatus 120 may implement procedure 400 to enhance its coexistence operation under FDD mode. With procedure 400, each of first apparatus 110 and second apparatus 120 may directly limit its transmission rate to a given value (e.g., a lower rate than a ‘normal’ rate when not in a coexistence scenario) instead performing numerous transmission retries to find a suitable transmission rate, thereby avoiding waste in airtime as well as excessive power consumption.

Procedure 400 may include one or more operations, actions, or functions as represented by one or more of blocks 410, 420, 430 and 440. Although illustrated as discrete blocks, various blocks of procedure 400 may be divided into additional blocks, combined into fewer blocks, or eliminated, depending on the desired implementation. For simplicity and in the interest of brevity, description of procedure 100 below is provided from the perspective of first apparatus 110, although the same may be applicable to second apparatus 120. Procedure 400 may begin at 410.

At 410, procedure 400 may involve second apparatus 120, as a peer apparatus (herein denoted as “device under test” or “DUT”) of first apparatus 110, transmitting one or more test signals to first apparatus 110 via one or more of its wireless systems (e.g., Wi-Fi and Bluetooth). Procedure 400 may proceed from 410 to 420.

At 420, procedure 400 may involve first apparatus 110 checking, identifying or otherwise determining packet success count(s) and/or packet failure count(s) in a histogram associated with past communications with second apparatus 120 to estimate path loss. For instance, first apparatus 110 may check a histogram of packet error rate(s) associated with past transmissions by second apparatus 120 to estimate path loss. Procedure 400 may proceed from 420 to 430.

At 430, procedure 400 may involve first apparatus 110 modifying or otherwise fine-tuning an initial transmission rate (TX_Rate_FDD_initial) for its current transmission rate. For instance, first apparatus 110 may increase the initial transmission rate in case a success rate according to the histogram is greater than a first threshold (e.g., X %). Moreover, first apparatus 110 may decrease the initial transmission rate in case the success rate according to the histogram is less than a second threshold (e.g., Y %), with first threshold and second threshold being the same or different. In case first threshold and second threshold are different, first threshold may be higher than second threshold. Procedure 400 may proceed from 430 to 440.

At 440, procedure 400 may involve first apparatus 110 determining its transmission rate to be either the initial transmission rate (TX_Rate_FDD_initial) as determined above or a normal rate when not in the coexistence scenario (Rate1(normal rate)), whichever is lower. That is, first apparatus 110 may set its transmission rate to be=Min(TX_Rate_FDD_initial, Rate1(normal rate)). Procedure 400 may proceed from 440 to 450.

At 450, procedure 400 may involve first apparatus 110 performing transmission at the above-determined transmission rate when in the coexistence scenario under FDD mode.

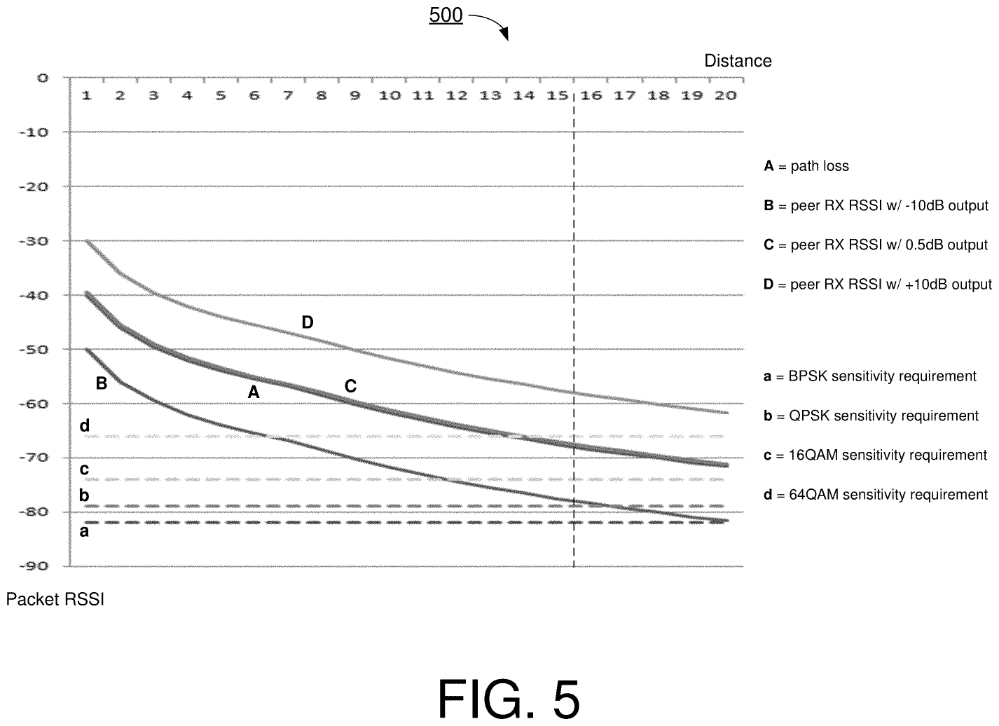

FIG. 5 illustrates an example simulation result 500 in accordance with the present disclosure. In the chart shown in FIG. 5, the vertical axis represents packet RSSI and the horizontal axis represents distance. Simulation result 500 shows the result for different output powers under a same path loss model. For receiving, different sensitivity levels are defined for different modulation schemes in receiving packets at a given distance. For instance, for binary phase shift keying (BPSK), sensitivity level may be at −82 dbm with a 0.5 db output power at 15 m. For quadrature phase shift keying (QPSK), sensitivity level may be at −79 dbm with a 0.5 db output power at 15 m. For 16-quadrature amplitude modulation (16QAM), sensitivity level may be at −74 dbm with a 0.5 db output power at 15 m. For 64-quadrature amplitude modulation (64QAM), sensitivity level may be at −66 dbm with a 0.5 db output power at 15 m. Thus, in the 15 m scenario and with 0.5 db output power, rate would be limited by the BPSK modulation scheme.

Thus, under various proposed schemes in accordance with the present disclosure, each of first apparatus 110 and second apparatus 120 may limit its transmission rate to satisfy power limitation and thereby gain more link budget under FDD coexistence. Under the proposed schemes, limitation on the transmission rate may be determined based on RSSI. In such cases, when rate determination fails (e.g., the determined initial transmission rate is its lowest transmission rate or lower), each of first apparatus 110 and second apparatus 120 may refrain or stop concurrence of BT_RX and Wi-Fi_TX or, alternatively, switch out of FDD mode (e.g., into TDD mode) or, alternatively, keep the lowest rate. Under the proposed schemes, each of first apparatus 110 and second apparatus 120 may fine-tune the limitation of its transmission rate based on a success rate from histogram. Advantageously, by limiting transmission rate when in a coexistence scenario under FDD mode, improved performance may be achieved (e.g., enhanced throughput). Moreover, by avoiding multiple retries in determining the transmission rate as in conventional approaches, waste of air resources may be avoided and power consumption may be reduced.

### Illustrative Implementations

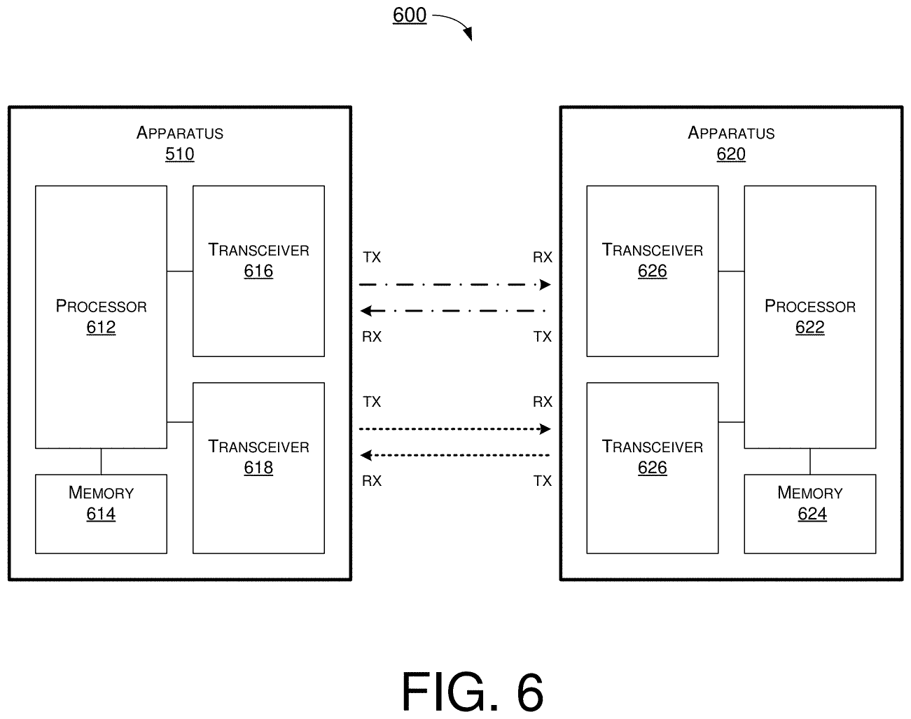

FIG. 6 illustrates an example system 600 having at least an example apparatus 610 and an example apparatus 620 in accordance with an implementation of the present disclosure. Each of apparatus 610 and apparatus 620 may perform various functions to implement schemes, techniques, processes and methods described herein pertaining to coexistence operation enhancement under FDD mode, including the various schemes described above with respect to various proposed designs, concepts, schemes, systems and methods described above as well as processes described below. For instance, apparatus 610 may be implemented in or as first apparatus 110 and apparatus 620 may be implemented in or as second apparatus 120.

Each of apparatus 610 and apparatus 620 may be a part of an electronic apparatus, such as a portable or mobile apparatus, a wearable apparatus, a wireless communication apparatus or a computing apparatus. For instance, each of apparatus 610 and apparatus 620 may be implemented in a smartphone, a smart watch, a personal digital assistant, a digital camera, or a computing equipment such as a tablet computer, a laptop computer, a notebook computer, a station (STA) or an access point (AP). Each of apparatus 610 and apparatus 620 may also be a part of a machine type apparatus, which may be an IoT apparatus such as an immobile or a stationary apparatus, a home apparatus, a wire communication apparatus or a computing apparatus. For instance, each of apparatus 610 and apparatus 620 may be implemented in a smart thermostat, a smart fridge, a smart door lock, a wireless speaker or a home control center.

In some implementations, each of apparatus 610 and apparatus 620 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Each of apparatus 610 and apparatus 620 may include at least some of those components shown in FIG. 6 such as a processor 612 and a processor 622, respectively, for example. Each of apparatus 610 and apparatus 620 may further include one or more other components not pertinent to the proposed scheme of the present disclosure (e.g., internal power supply, display device and/or user interface device), and, thus, such component(s) of apparatus 610 and apparatus 620 are neither shown in FIG. 6 nor described below in the interest of simplicity and brevity.

In one aspect, each of processor 612 and processor 622 may be implemented in the form of one or more single-core processors, one or more multi-core processors, one or more RISC processors or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including those pertaining to coexistence operation enhancement under FDD mode in accordance with various implementations of the present disclosure.

In some implementations, apparatus 610 may also include a first transceiver 616 and a second transceiver 618 coupled to processor 612. First transceiver 616 may include a transmitter capable of wirelessly transmitting and a receiver capable of wirelessly receiving data using a first technology. Second transceiver 618 may include a transmitter capable of wirelessly transmitting and a receiver capable of wirelessly receiving data using a second technology. Similarly, apparatus 620 may also include a first transceiver 626 and a second transceiver 628 coupled to processor 622. First transceiver 626 may include a transmitter capable of wirelessly transmitting and a receiver capable of wirelessly receiving data using first technology. Second transceiver 628 may include a transmitter capable of wirelessly transmitting and a receiver capable of wirelessly receiving data using second technology. First technology and second technology may include, for example and without limitation, Wi-Fi and Bluetooth.

In some implementations, apparatus 610 may further include a memory 614 coupled to processor 612 and capable of being accessed by processor 612 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of apparatus 610 and apparatus 620 may be a communication entity capable of communicating with each other using various proposed schemes in accordance with the present disclosure. For illustrative purposes and without limitation, a description of capabilities of apparatus 610, as first apparatus 110, and apparatus 620, as second apparatus 120, is provided below. It is noteworthy that, although the example implementations described below are provided in the context of certain wireless technologies such as Wi-Fi and Bluetooth, the same may be implemented in the content of other wireless technologies.

Under a proposed scheme in accordance with the present disclosure, with apparatus 610 implemented in or as apparatus 110 and apparatus 620 implemented in or as apparatus 120, processor 612 of apparatus 610 may identify an onset of a coexistence scenario involving simultaneous transmission and receiving using a first wireless technology and a second wireless technology different from the first technology, respectively, in wireless communications with apparatus 620 under a FDD mode. In some implementations, the first wireless technology may include Bluetooth and wherein the second wireless technology may include Wi-Fi, or vice versa. Moreover, processor 612 may determine an upper limit on transmission rates responsive to identifying the onset of the coexistence scenario. Furthermore, processor 612 may perform, via first transceiver 616 and second transceiver 618, transmissions at or without exceeding the upper limit until the coexistence scenario is over.

In some implementations, in determining the upper limit on transmission rates, processor 612 may determine the upper limit on transmission rates based on an RSSI of a transmission from apparatus 620 to the first apparatus.

In some implementations, in determining the upper limit on transmission rates based on the RSSI of the transmission from apparatus 620 to apparatus 610, processor 612 may perform certain operations. For instance, processor 612 may receive a signal from apparatus 620. Additionally, processor 612 may determine a path loss by subtracting the RSSI and a delta margin from an estimated transmission power of the second apparatus. Moreover, processor 612 may determine whether a power level corresponding to an initial transmission rate is greater than a receiving sensitivity requirement.

In some implementations, responsive to the power level corresponding to the initial transmission rate being less than the receiving sensitivity requirement or the upper limit being a lowest transmission rate among a plurality of possible transmission rates of the first apparatus, processor 612 may also control first transceiver 616 of apparatus 610 that uses the first wireless technology to stop or avoid concurrence of first transceiver 616 receiving using the first wireless technology while second transceiver 618 of apparatus 610 is transmitting using the second technology. For instance, in cases that first wireless technology including Bluetooth and second wireless technology including Wi-Fi, processor 612 may stop concurrence of BT_RX and Wi-Fi_TX.

In some implementations, responsive to the power level corresponding to the initial transmission rate being less than the receiving sensitivity requirement or the upper limit being a lowest transmission rate among a plurality of possible transmission rates of the first apparatus, processor 612 may switch the wireless communications with apparatus 620 out of the FDD mode. For instance, processor 612 may switch the wireless communications with apparatus 620 to a TDD mode.

In some implementations, responsive to the power level corresponding to the initial transmission rate being less than the receiving sensitivity requirement or the upper limit being a lowest transmission rate among a plurality of possible transmission rates of the first apparatus, processor 612 may further maintain a transmission rate at the initial transmission rate for transmissions throughout the coexistence scenario.

In some implementations, responsive to the power level corresponding to the initial transmission rate being greater than the receiving sensitivity requirement, processor 612 may further set a transmission rate for transmissions throughout the coexistence scenario to be either the initial transmission rate or a normal rate for a non-coexistence scenario, whichever is lower.

In some implementations, in determining the upper limit on transmission rates, processor 612 may determine the upper limit on transmission rates based on a histogram of packet success counts or packet failure counts associated with past communications with the second apparatus.

In some implementations, in determining the upper limit on transmission rates based on the histogram, processor 612 may perform certain operations. For instance, processor 612 may modify an initial transmission rate based on the histogram. Moreover, processor 612 may set a transmission rate for transmissions throughout the coexistence scenario to be either the initial transmission rate or a normal rate for a non-coexistence scenario, whichever is lower.

In some implementations, in modifying the initial transmission rate based on the histogram, processor 612 may increase the initial transmission rate in case a success rate according to the histogram is greater than a first threshold or, alternatively, processor 612 may decrease the initial transmission rate in case the success rate according to the histogram is less than a second threshold different from the first threshold.

### Illustrative Processes

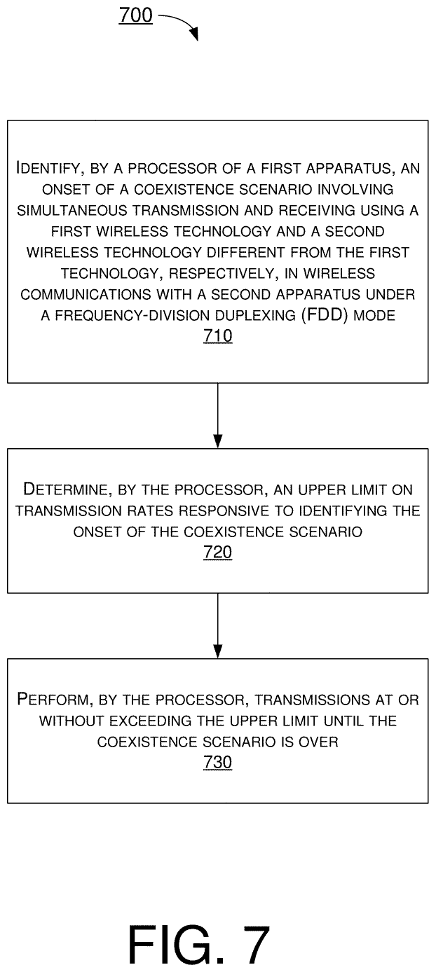

FIG. 7 illustrates an example process 700 in accordance with an implementation of the present disclosure. Process 700 may represent an aspect of implementing various proposed designs, concepts, schemes, systems and methods described above. More specifically, process 700 may represent an aspect of the proposed concepts and schemes pertaining to coexistence operation enhancement under FDD mode in accordance with the present disclosure. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed repeatedly or iteratively. Process 700 may be implemented by or in apparatus 610 and apparatus 620 as well as any variations thereof. Solely for illustrative purposes and without limiting the scope, process 700 is described below in the context of apparatus 610 implemented in or as first apparatus 110 and apparatus 620 implemented in or as second apparatus 120. Process 700 may begin at block 710.

At 710, process 700 may involve processor 612 of apparatus 610 identifying an onset of a coexistence scenario involving simultaneous transmission and receiving using a first wireless technology and a second wireless technology different from the first technology, respectively, in wireless communications with apparatus 620 under a FDD mode. In some implementations, the first wireless technology may include Bluetooth and wherein the second wireless technology may include Wi-Fi, or vice versa. Process 700 may proceed from 710 to 720.

At 720, process 700 may involve processor 612 determining an upper limit on transmission rates responsive to identifying the onset of the coexistence scenario. Process 700 may proceed from 720 to 730.

At 730, process 700 may involve processor 612 performing, via first transceiver 616 and second transceiver 618, transmissions at or without exceeding the upper limit until the coexistence scenario is over.

In some implementations, in determining the upper limit on transmission rates, process 700 may involve processor 612 determining the upper limit on transmission rates based on an RSSI of a transmission from apparatus 620 to the first apparatus.

In some implementations, in determining the upper limit on transmission rates based on the RSSI of the transmission from apparatus 620 to apparatus 610, process 700 may involve processor 612 performing certain operations. For instance, process 700 may involve processor 612 receiving a signal from apparatus 620. Additionally, process 700 may involve processor 612 determining a path loss by subtracting the RSSI and a delta margin from an estimated transmission power of the second apparatus. Moreover, process 700 may involve processor 612 determining whether a power level corresponding to an initial transmission rate is greater than a receiving sensitivity requirement.

In some implementations, responsive to the power level corresponding to the initial transmission rate being less than the receiving sensitivity requirement or the upper limit being a lowest transmission rate among a plurality of possible transmission rates of the first apparatus, process 700 may further involve processor 612 controlling first transceiver 616 of apparatus 610 that uses the first wireless technology to stop or avoid concurrence of first transceiver 616 receiving using the first wireless technology while second transceiver 618 of apparatus 610 is transmitting using the second technology. For instance, in cases that first wireless technology including Bluetooth and second wireless technology including Wi-Fi, process 700 may involve processor 612 stopping concurrence of BT_RX and Wi-Fi_TX.

In some implementations, responsive to the power level corresponding to the initial transmission rate being less than the receiving sensitivity requirement or the upper limit being a lowest transmission rate among a plurality of possible transmission rates of the first apparatus, process 700 may further involve processor 612 switching the wireless communications with apparatus 620 out of the FDD mode. For instance, process 700 may involve processor 612 switching the wireless communications with apparatus 620 to a TDD mode.

In some implementations, responsive to the power level corresponding to the initial transmission rate being less than the receiving sensitivity requirement or the upper limit being a lowest transmission rate among a plurality of possible transmission rates of the first apparatus, process 700 may further involve processor 612 maintaining a transmission rate at the initial transmission rate for transmissions throughout the coexistence scenario.

In some implementations, responsive to the power level corresponding to the initial transmission rate being greater than the receiving sensitivity requirement, process 700 may further involve processor 612 setting a transmission rate for transmissions throughout the coexistence scenario to be either the initial transmission rate or a normal rate for a non-coexistence scenario, whichever is lower.

In some implementations, in determining the upper limit on transmission rates, process 700 may involve processor 612 determining the upper limit on transmission rates based on a histogram of packet success counts or packet failure counts associated with past communications with the second apparatus.

In some implementations, in determining the upper limit on transmission rates based on the histogram, process 700 may involve processor 612 performing certain operations. For instance, process 700 may involve processor 612 modifying an initial transmission rate based on the histogram. Moreover, process 700 may involve processor 612 setting a transmission rate for transmissions throughout the coexistence scenario to be either the initial transmission rate or a normal rate for a non-coexistence scenario, whichever is lower.

In some implementations, in modifying the initial transmission rate based on the histogram, process 700 may involve processor 612 increasing the initial transmission rate in case a success rate according to the histogram is greater than a first threshold or, alternatively, process 700 may involve processor 612 decreasing the initial transmission rate in case the success rate according to the histogram is less than a second threshold different from the first threshold.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
identifying, by a processor of a first apparatus, an onset of a coexistence scenario involving simultaneous transmission and receiving using a first wireless technology and a second wireless technology different from the first technology, respectively, in wireless communications with a second apparatus under a frequency-division duplexing (FDD) mode;
determining, by the processor, an upper limit on transmission rates responsive to identifying the onset of the coexistence scenario; and
performing, by the processor, transmissions at or without exceeding the upper limit until the coexistence scenario is over.

2. The method of claim 1, wherein the determining of the upper limit on transmission rates comprises determining the upper limit on transmission rates based on a received signal strength indication (RSSI) of a transmission from the second apparatus to the first apparatus.

3. The method of claim 2, wherein the determining of the upper limit on transmission rates based on the RSSI of the transmission from the second apparatus to the first apparatus comprises:
receiving a signal from the second apparatus;
determining a path loss by subtracting the RSSI and a delta margin from an estimated transmission power of the second apparatus; and
determining whether a power level corresponding to an initial transmission rate is greater than a receiving sensitivity requirement.

4. The method of claim 3, wherein, responsive to the power level corresponding to the initial transmission rate being less than the receiving sensitivity requirement or the upper limit being a lowest transmission rate among a plurality of possible transmission rates of the first apparatus, further comprising:
controlling a first transceiver of the first apparatus that uses the first wireless technology to stop or avoid concurrence of the first transceiver receiving using the first wireless technology while a second transceiver of the first apparatus is transmitting using the second technology.

5. The method of claim 4, wherein the first wireless technology comprises Bluetooth, and wherein the second wireless technology comprises Wi-Fi.

6. The method of claim 3, wherein, responsive to the power level corresponding to the initial transmission rate being less than the receiving sensitivity requirement or the upper limit being a lowest transmission rate among a plurality of possible transmission rates of the first apparatus, further comprising:
switching the wireless communications with the second apparatus out of the FDD mode.

7. The method of claim 6, wherein the switching the wireless communications with the second apparatus out of the FDD mode comprises switching the wireless communications with the second apparatus to a time-division duplexing (TDD) mode.

8. The method of claim 3, wherein, responsive to the power level corresponding to the initial transmission rate being less than the receiving sensitivity requirement or the upper limit being a lowest transmission rate among a plurality of possible transmission rates of the first apparatus, further comprising:
maintaining a transmission rate at the initial transmission rate for transmissions throughout the coexistence scenario.

9. The method of claim 3, wherein, responsive to the power level corresponding to the initial transmission rate being greater than the receiving sensitivity requirement, further comprising:
setting a transmission rate for transmissions throughout the coexistence scenario to be either the initial transmission rate or a normal rate for a non-coexistence scenario, whichever is lower.

10. The method of claim 1, wherein the determining of the upper limit on transmission rates comprises determining the upper limit on transmission rates based on a histogram of packet success counts or packet failure counts associated with past communications with the second apparatus.

11. The method of claim 10, wherein the determining of the upper limit on transmission rates based on the histogram comprises:
modifying an initial transmission rate based on the histogram; and
setting a transmission rate for transmissions throughout the coexistence scenario to be either the initial transmission rate or a normal rate for a non-coexistence scenario, whichever is lower.

12. The method of claim 11, wherein the modifying of the initial transmission rate based on the histogram comprise:
increasing the initial transmission rate in case a success rate according to the histogram is greater than a first threshold; or
decreasing the initial transmission rate in case the success rate according to the histogram is less than a second threshold different from the first threshold.

13. The method of claim 1, wherein the first wireless technology comprises Bluetooth, and wherein the second wireless technology comprises Wi-Fi.

14. An apparatus, comprising:
a first transceiver configured to wirelessly transmit and receive using a first wireless technology;
a second transceiver configured to wirelessly transmit and receive using a second technology different from the first technology; and
a processor coupled to control the first transceiver and the second transceiver, the processor configured to perform operations comprising:
identifying an onset of a coexistence scenario involving simultaneous transmission and receiving using the first wireless technology and the second wireless technology, respectively, in wireless communications with one other apparatus under a frequency-division duplexing (FDD) mode;
determining an upper limit on transmission rates responsive to identifying the onset of the coexistence scenario; and
performing, via the first transceiver and the second transceiver, transmissions at or without exceeding the upper limit until the coexistence scenario is over.

15. The apparatus of claim 14, wherein, in determining the upper limit on transmission rates, the processor is configured to determine the upper limit on transmission rates based on a received signal strength indication (RSSI) of a transmission from the other apparatus to the first apparatus by performing operations comprising:
receiving a signal from the other apparatus;
determining a path loss by subtracting the RSSI and a delta margin from an estimated transmission power of the other apparatus; and
determining whether a power level corresponding to an initial transmission rate is greater than a receiving sensitivity requirement.

16. The method of claim 15, wherein, responsive to the power level corresponding to the initial transmission rate being less than the receiving sensitivity requirement or the upper limit being a lowest transmission rate among a plurality of possible transmission rates of the first apparatus, the processor is further configured to perform a first operation, a second operation, or a third operation, and wherein:
the first operation comprises controlling a first transceiver of the first apparatus that uses the first wireless technology to stop or avoid concurrence of the first transceiver receiving using the first wireless technology while a second transceiver of the first apparatus is transmitting using the second technology,
the second operation comprises switching the wireless communications with the other apparatus out of the FDD mode, and
the third operation comprises maintaining a transmission rate at the initial transmission rate for transmissions throughout the coexistence scenario.

17. The apparatus of claim 16, wherein the first wireless technology comprises Bluetooth, wherein the second wireless technology comprises Wi-Fi, and wherein the switching the wireless communications with the other apparatus out of the FDD mode comprises switching the wireless communications with the other apparatus to a time-division duplexing (TDD) mode.

18. The apparatus of claim 15, wherein, responsive to the power level corresponding to the initial transmission rate being greater than the receiving sensitivity requirement, the processor is further configured to set a transmission rate for transmissions throughout the coexistence scenario to be either the initial transmission rate or a normal rate for a non-coexistence scenario, whichever is lower.

19. The apparatus of claim 14, wherein, in determining the upper limit on transmission rates, the processor is configured to determine the upper limit on transmission rates based on a histogram of packet success counts or packet failure counts associated with past communications with the other apparatus by performing operations comprising:
modifying an initial transmission rate based on the histogram; and
setting a transmission rate for transmissions throughout the coexistence scenario to be either the initial transmission rate or a normal rate for a non-coexistence scenario, whichever is lower.

20. The apparatus of claim 19, wherein, in modifying the initial transmission rate based on the histogram, the processor is configured to perform either:
increasing the initial transmission rate in case a success rate according to the histogram is greater than a first threshold; or
decreasing the initial transmission rate in case the success rate according to the histogram is less than a second threshold different from the first threshold.
